(19) United States
(12) Patent Application Publication
(10) Pub. No.: US 2026/0023200 A1
(43) Pub. Date: Jan. 22, 2026

(54) OPTICAL MODULE

(71) Applicant: Asahi Kasei Microdevices Corporation, Tokyo (JP)

(72) Inventor: Kengo SASAYAMA, Tokyo (JP)

(73) Assignee: Asahi Kasei Microdevices Corporation, Tokyo (JP)

(21) Appl. No.: 19/263,505

(22) Filed: Jul. 9, 2025

(30) Foreign Application Priority Data
Jul. 17, 2024 (JP) 2024-114230
May 26, 2025 (JP) 2025-087473

(51) Int. Cl. G02B 5/28; G02B 5/20

(52) U.S. Cl. CPC G02B 5/281; G02B 5/208

(57) ABSTRACT

A first and second optical filter of an optical module include 50 nm or more of a common transmission band with a transmittance of 60% or more in the wavelength range of 2000 to 10000 nm, a total of 200 nm or more of a certain wavelength range in which a transmittance difference is 20% or more outside the common transmission band, and a total of 1000 nm or more of a wavelength range in which the transmittance difference is less than 20% and the transmittance is less than 60% in a band closer to the common transmission band than the certain wavelength range on both sides of the common transmission band. A sensitivity in a cutoff band is 5% or less of the peak sensitivity as a result of multiplying a sensitivity spectrum of the infrared optical element by a transmission spectra of the plurality of optical filters.

### CROSS-REFERENCE TO RELATED APPLICATION

The present application claims priority to Japanese Patent Application No. 2024-114230 filed on Jul. 17, 2024 and Japanese Patent Application No. 2025-087473 filed on May 26, 2025, the entire contents of which are incorporated herein by reference.

### TECHNICAL FIELD

The present disclosure relates to an optical module.

### BACKGROUND

Non-dispersive infrared (NDIR) absorption gas concentration measuring devices are known as conventional gas concentration measuring devices that measure concentration of a gas to be measured in the atmosphere. Different kinds of gas absorb infrared light at different wavelengths, and a non-dispersive infrared absorption gas concentration measuring device utilizes this principle and measures gas concentration by detecting the amount of absorption. For example, a non-dispersive infrared absorption gas concentration measuring device comprises an infrared optical element and an optical filter that transmits infrared light of a specific wavelength according to the gas to be measured. For example, Patent Literature (PTL) 1 discloses a gas sensor that includes a plurality of optical filters.

### CITATION LIST

### Patent Literature

PTL 1: U.S. Pat. No. 11,499,914 B2

### SUMMARY

The gas to be measured is not limited to carbon dioxide gas, and may be any of various gases. An optimal combination of the infrared optical element and the optical filter for each gas to be measured has not yet been studied. In particular, optical filter specifications have not yet been optimized. Moreover, high-precision optical filters tend to have a thicker multilayer film. As a result, processability and yield have decreased, leading to a reduction in the mass productivity of optical modules that include optical filters.

In view of such circumstances, it would be helpful to provide an optical module that can improve mass productivity. Here, the optical module includes an infrared optical element and an optical filter, and is a module used in devices such as concentration measurement devices, infrared radiation thermometers (non-contact thermometers), infrared spectroscopic imaging, and human detection sensors. The optical module is an optical component in which the infrared optical element and the optical filter are arranged and packaged while their positional relationship is maintained so as to achieve desired characteristics.
(1) An optical module according to an embodiment of the present disclosure includes:
   a plurality of optical filters including at least a first optical filter and a second optical filter separate from the first optical filter, and an infrared optical element having peak sensitivity in a wavelength range of 2000 nm to 10000 nm, wherein
   at least one of the first optical filter and the second optical filter is configured to include a substrate and a multilayer film formed on at least one surface of the substrate, the multilayer film including a plurality of layers having different refractive indices,
   the first optical filter and the second optical filter include 50 nm or more of a common transmission band with a transmittance of 60% or more in the wavelength range of 2000 nm to 10000 nm, a total of 200 nm or more of a wavelength range in which a transmittance difference is 20% or more outside the common transmission band, and a total of 1000 nm or more of a wavelength range in which the transmittance difference is less than 20% and the transmittance is less than 60% in a band closer to the common transmission band than the wavelength range in which the transmittance difference is 20% or more on both sides of the common transmission band, and
   a sensitivity in a cutoff band is 5% or less of the peak sensitivity as a result of multiplying a sensitivity spectrum of the infrared optical element by a transmission spectra of the plurality of optical filters.
(2) As an embodiment of the present disclosure, in (1),
   at least one of the plurality of optical filters is directly laminated on the infrared optical element and shares a substrate with the infrared optical element.
(3) As an embodiment of the present disclosure, in (1),
   a filter substrate, which is at least one substrate among the plurality of optical filters, is of a different type from an optical element substrate, which is a substrate of the infrared optical element, and
   the filter substrate and the optical element substrate are bonded together.
(4) As an embodiment of the present disclosure, in any one of (1) to (3),
   at least one of the plurality of optical filters has a total film thickness of the multilayer film of λp×1.5 nm or less, where λp is a center wavelength of the transmission band.
(5) As an embodiment of the present disclosure, in any one of (1) to (4),
   the plurality of optical filters includes the first optical filter and the second optical filter, and
   a difference between a half-width of the first optical filter and a half-width of the second optical filter is 1500 nm or less.
(6) As an embodiment of the present disclosure, in any one of (1) to (5),
   each of the plurality of optical filters including the multilayer film has a total film thickness of the multilayer of 14 μm or less.
(7) As an embodiment of the present disclosure, in any one of (1) to (6),
   the infrared optical element has a ratio of maximum sensitivity to minimum sensitivity of 20 or more in the wavelength range of 2000 nm to 10000 nm.
(8) As an embodiment of the present disclosure, in any one of (1) to (7),
   the plurality of optical filters includes, in the wavelength range of 2000 nm to 10000 nm, a total of 50 nm or more of a wavelength range in which a transmittance difference between at least two of the plurality of optical filters is 30% or more, and
   in the wavelength range of 2000 nm to 10000 nm, when the sensitivity spectrum of the infrared optical element is multiplied by the transmission spectra of the plurality of optical filters, the sensitivity in the cutoff band is 2% or less of the peak sensitivity.
(9) As an embodiment of the present disclosure, in any one of (1) to (8),
   in any 1000 nm interval of the cutoff band, a wavelength range exists such that the transmittance difference is 5% or less between wavelength ranges in which the transmittance difference is 20% or more for at least two of the plurality of optical filters.
(10) As an embodiment of the present disclosure, in any one of (1) to (9),
   a slope of a transmission spectrum of at least one of the plurality of optical filters is 3.3% or more.
(11) As an embodiment of the present disclosure, in any one of (1) to (10),
   all of the plurality of optical filters are configured to include a substrate and a multilayer film formed on at least one surface of the substrate, the multilayer film including a plurality of layers having different refractive indices.
(12) As an embodiment of the present disclosure, in any one of (1) to (11),
   in the common transmission band, a relationship of 0.5< (A/B)<2 is satisfied, where A is a half-width of one optical filter and B is a half-width of another optical filter among the plurality of optical filters.
(13) As an embodiment of the present disclosure, in (12),
   a relationship 0.7< (A/B)<1.3 is satisfied for A and B.
(14) As an embodiment of the present disclosure, in any one of (1) to (13),
   two or more film thicknesses among the plurality of optical filters are equal to or less than a center wavelength×1.5.
(15) As an embodiment of the present disclosure, in any one of (1) to (14),
   when the transmission spectra of the plurality of optical filters are multiplied, a slope of a resulting transmission spectrum is smaller than a slope of the transmission spectrum of all individual optical filters.

According to the present disclosure, it is possible to provide an optical module that can improve mass productivity.

### BRIEF DESCRIPTION OF THE DRAWINGS

In the accompanying drawings:

FIG. 1 is a diagram illustrating an example of a cross-section of an optical filter;

FIG. 2 is a diagram illustrating an example of a concentration measurement device including an optical module according to an embodiment of the present disclosure;

FIG. 3 is a diagram for comparing an optical filter in the optical module according to an embodiment of the present disclosure with an optical filter according to a comparative example;

FIG. 4 is a diagram illustrating the differences between the optical filter according to the comparative examples and the optical filter of the present disclosure;

FIG. 5 is a diagram illustrating the configuration of the optical filter and an infrared optical element in the optical module;

FIG. 6 is a diagram illustrating the transmittance of Examples;

FIG. 7 is a diagram illustrating the characteristics of the Examples; and

FIG. 8 is a diagram illustrating a laminated structure of the infrared optical element of the Examples.

### DETAILED DESCRIPTION

Hereinafter, the optical module according to an embodiment of the present disclosure will be described with reference to the drawings.

### (Optical Module)

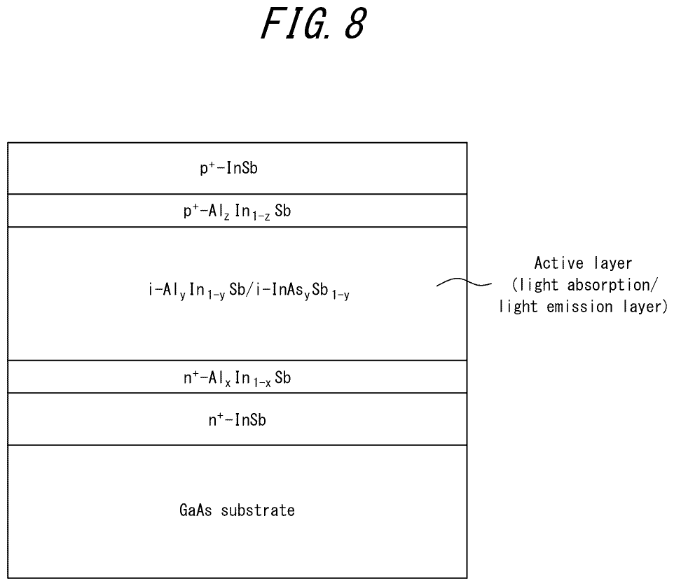

The optical module according to the present embodiment includes a plurality of optical filters and an infrared optical element. In the present embodiment, each of the plurality of optical filters (that is, all of the optical filters) has a configuration that includes a substrate and a multilayer film formed on at least one surface of the substrate, the multilayer film including a plurality of layers having different refractive indices. However, it suffices for at least one of the plurality of optical filters to be configured to include a substrate and a multilayer film. An infrared optical element is an infrared light-receiving element or an infrared light-emitting element, and is a collective name applied to either element. Furthermore, hereinafter, receive/emit light means having at least one of the functions of light-receiving or light-emitting. The infrared optical element is configured to include, for example, a first conductivity type semiconductor layer, an active layer, and a second conductivity type semiconductor layer, and receives/emits infrared light. That is, the optical module according to the present embodiment is an infrared module. An infrared light-emitting element is realized by a structure described below (see FIG. 8), and an infrared light-receiving element is realized by the same structure. The infrared light-emitting element may specifically be a light emitting diode (LED). The infrared light-receiving element may specifically be a photodiode (PD). Here, the optical module according to the present embodiment includes a plurality of optical filters, but in the following, reference may simply be made to optical filters when the explanation is not about each of the plurality of optical filters.

The following description assumes that the optical device according to the present embodiment is used in a concentration measuring device. As described above, the optical module is an optical component in which the infrared optical element and the optical filter are arranged and packaged while their positional relationship is maintained so as to achieve desired characteristics. Furthermore, the optical module is not limited to concentration measurement devices and may be used in infrared radiation thermometers and the like.

In the present embodiment, the concentration measurement device is a gas sensor that measures the concentration of a gas to be measured. The concentration measuring device may be, for example, a non-dispersive infrared (NDIR) absorption gas sensor including a light-receiver that receives infrared light transmitted through gas. Furthermore, the concentration measuring device may be, for example, a photoacoustic gas sensor that measures gas concentration by using a high-performance microphone to pick up, as sound, the vibration of gas molecules that have absorbed light.

As will be described in detail later, the plurality of optical filters include at least a first optical filter and a second optical filter that is separate from the first optical filter. The first optical filter and the second optical filter include 50 nm or more of a common transmission band with a transmittance of 60% or more in a wavelength range of 2000 nm to 10000 nm, and a total of 200 nm or more of a wavelength range in which a transmittance difference between at least two of the plurality of optical filters is 20% or more outside the common transmission band. Furthermore, the first optical filter and the second optical filter include a total of 1000 nm or more of a wavelength range in which the transmittance difference is less than 20% and the transmittance is less than 60% in a band closer to the common transmission band than the wavelength range in which the transmittance difference is 20% or more on both sides of the common transmission band. In addition, the infrared optical element has peak sensitivity in the wavelength range of 2000 nm to 10000 nm, and the sensitivity in a cutoff band is 5% or less of the peak sensitivity as a result of multiplying the sensitivity spectrum of the infrared optical element by the transmission spectra of the plurality of optical filters. In other words, when the sensitivity spectrum of the infrared optical element is multiplied by the transmission spectra of the plurality of optical filters, the sensitivity in a cutoff band is 5% or less of the peak sensitivity. Here, multiplying refers to multiplying the sensitivity spectrum of the infrared optical element and the transmission spectra of the plurality of optical filters for each wavelength. The cutoff band is a wavelength range that does not require sensitivity in the design of the optical module. For example, the cutoff band includes a wavelength range in which at least one of the infrared light-emitting element and the infrared light-receiving element used together with the optical filters in the optical module does not have sensitivity. Also, for example, the cutoff band includes a wavelength range where the transmittance of the optical filter is low. Low transmittance of the optical filter is not limited to a transmittance of 0% and may include cases in which the transmittance is 5% or less, for example. On the other hand, the transmission band is a band that does not correspond to the cutoff band and is at least a part of the wavelength range in which the infrared light-emitting element and infrared light-receiving element have sensitivity.

According to the optical module of the present embodiment, it is possible to selectively receive or emit only infrared light in the desired wavelength band while using a simplified optical filter. By using a simplified optical filter, the optical module according to the present embodiment can be made smaller compared to conventional modules that use non-simplified optical filters. In the optical module according to the present embodiment, the optical filter is composed of a plurality of simplified optical filters. By dividing up functions among the plurality of simplified optical filters, a filter with the overall desired characteristics can be constructed, thereby making it possible to provide an optical module that allows for improved mass productivity, as described below. Here, each of the plurality of simplified optical filters cannot achieve the desired characteristics alone. The optical module according to the present embodiment is configured by combining such a plurality of simplified optical filters.

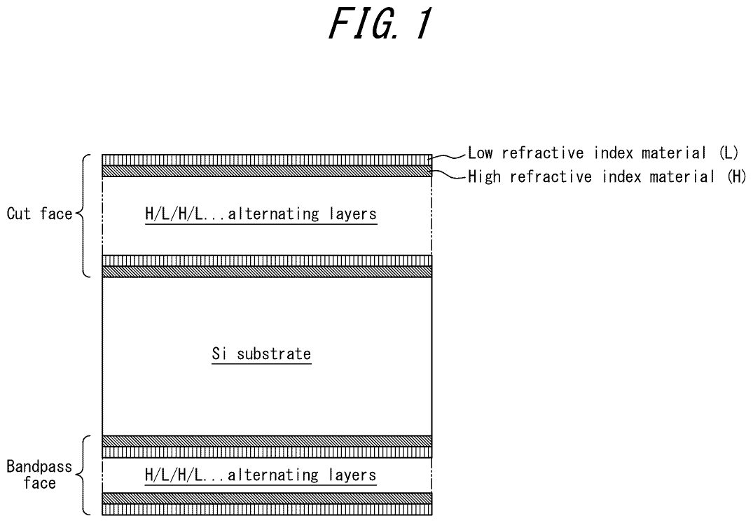

FIG. 1 illustrates an example of a cross-section of an optical filter. According to the present embodiment, the optical filter includes alternating layers of low refractive index material (L) made of silicon monoxide (SiO), silicon dioxide (SiO₂), titanium dioxide (TiO₂), zinc sulfide (ZnS), aluminum oxide (Al₂O₃), or the like, and high refractive index material (H) made of Si, Ge, or the like, on both sides of a Si substrate. As the low refractive index material (L), a material having a refractive index from 1.2 to 2.5 is preferably selected. As the high refractive index material (H), a material having a refractive index that is at least 0.5 more than that of the low refractive index material (L) is preferably selected. The multilayer films of alternating layers are each formed so that the layer directly on the Si substrate is the high refractive index material (H). However, the optical filter is not limited to the configuration illustrated in FIG. 1. For example, the high refractive index material (H) need not be directly on the substrate.

According to the present embodiment, the optical filter is an interference bandpass filter in the mid-infrared range. Typically, interference bandpass filters in the mid-infrared range have a large number of layers and are prone to increased defects during film formation. Therefore, the number of layers in the optical filter is preferably small. However, when the number of layers in the optical filter is simply reduced to simplify the optical filter, the precision of the gas sensor may degrade.

As a result of studying optimal combinations of infrared optical elements and optical filters, I achieved an optical module such that precision does not degrade even using a “simplified optical filter” configured by a plurality of optical filters, as described below.

Here, a simplified optical filter is an optical filter that does not cut a range where a sensor has no sensitivity, and therefore does not include layers of optical thin film required to cut the range. In the present embodiment, an overall simplified optical filter is realized by combining the transmission spectra of a plurality of optical filters. Therefore, it is possible to further reduce the number of layers for each optical filter, thereby reducing defects during film formation. For example, a decrease in warpage caused by multilayer stacking suppresses occurrence of chipping during dicing and improves mass production stability. In other words, it is possible to suppress the decrease in workability and yield.

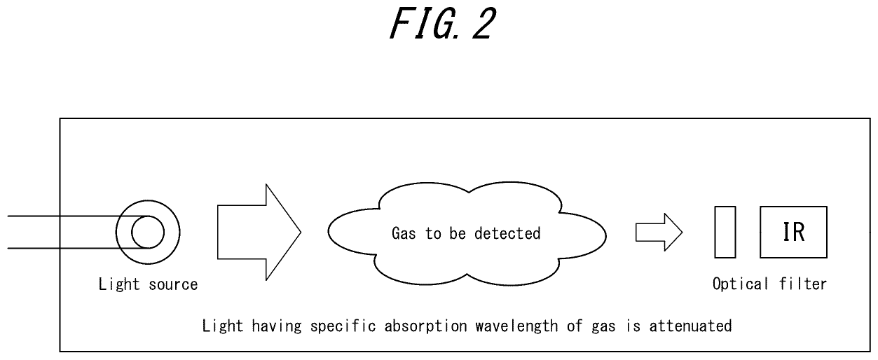

FIG. 2 is a diagram illustrating an example of a concentration measuring device using the optical module according to the present embodiment. In the optical module according to the present embodiment, as illustrated in FIG. 2, an infrared light-receiving element (IR) is disposed in the optical path of infrared light to be output from an infrared light-emitting element (light source), and an optical filter that selectively transmits the absorption wavelength of a gas to be detected is disposed in front of the infrared light-receiving element. The optical module corresponds to, for example, the part with the infrared light-emitting element and optical filter, or the part that further includes the infrared light-receiving element.

Here, the gas to be measured by the concentration measurement device is, for example, carbon dioxide (CO₂), but this example is not limiting. For example, the gas to be measured may be water vapor, carbon monoxide, nitrogen monoxide, ammonia, sulfur dioxide, alcohol, formaldehyde, methane, propane, or the like.

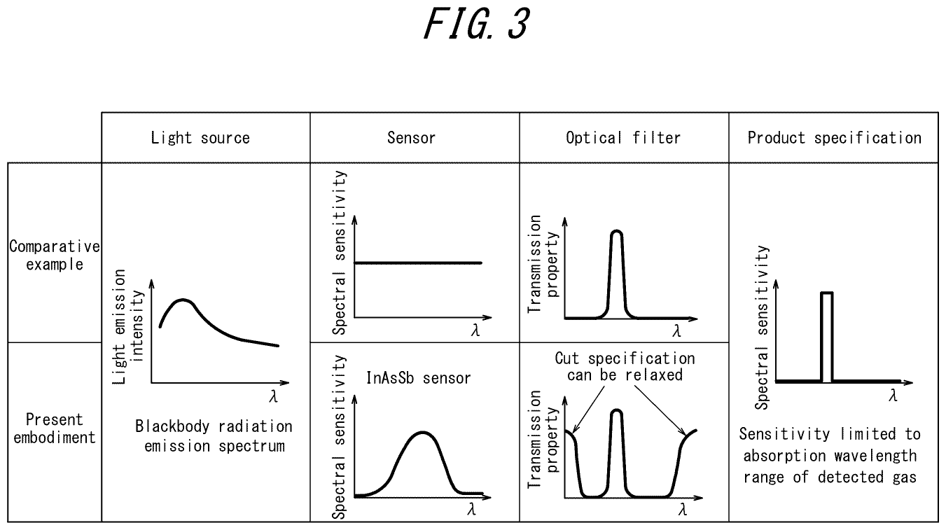

FIG. 3 is a diagram for comparing the optical filter in the optical module according to the present embodiment with an optical filter according to a comparative example. The sensor (infrared light-receiving element) of the comparative example has no wavelength selectivity in the spectral sensitivity (the sensitivity does not change based on wavelength). In contrast, the sensor included in the optical module (or included in the concentration measuring device using the optical module) according to the present embodiment has wavelength selectivity. Therefore, according to the present embodiment, there is no need for the optical filter to cut wavelengths for which there is no sensitivity, and the optical filter can be simplified. Similarly, in the case of an infrared light-emitting element that has wavelength selectivity in emission intensity, there is no need for the optical filter to cut wavelengths that are not emitted, and the optical filter can be simplified. Here, in FIG. 3, the wavelengths for which there is no sensitivity and the wavelengths that are not emitted are illustrated both on the wavelength side longer than the peak wavelength (high wavelength side) and on the wavelength side shorter than the peak wavelength (short wavelength side), but this is only a conceptual example. It suffices for the cut specification of the optical filter to be relaxed on at least one of the high wavelength side and the short wavelength side.

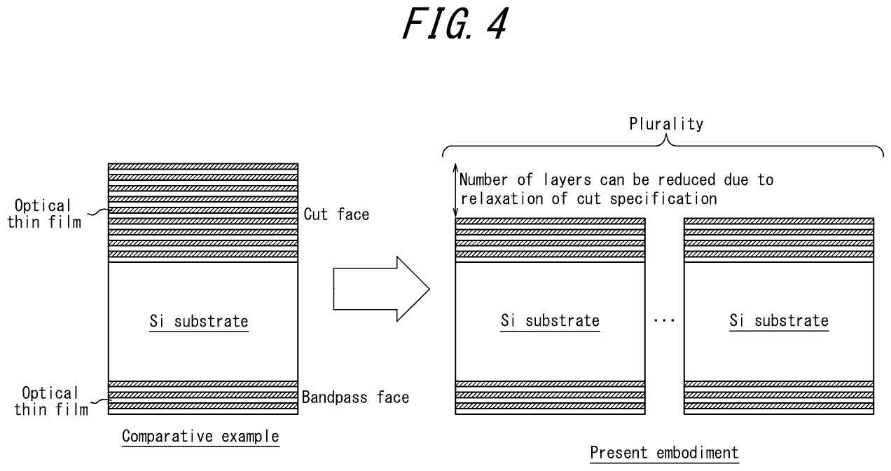

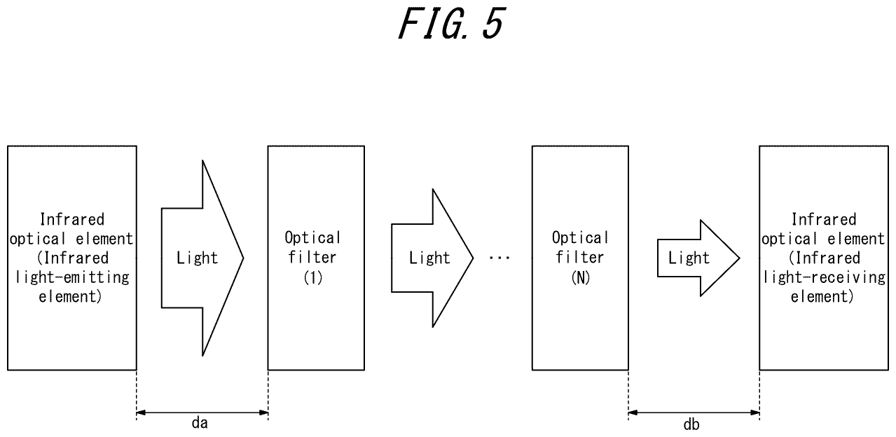

FIG. 4 is a diagram illustrating the differences between the optical filter according to the comparative example and the optical filter of the present disclosure. In the optical filter of the optical module according to the present embodiment, functions are divided among a plurality of optical filters, allowing for a reduction in the number of layers per optical filter. The number of optical filters included in the optical module according to the present embodiment will be described below as being 2 or 3 as examples, but the number may be 4 or more. That is, the optical module includes N optical filters (see FIG. 5), where N is an integer of 2 or more.

FIG. 5 is a diagram illustrating the configuration of the optical filter and an infrared optical element in the optical module. The optical filters are arranged in the optical path downstream from the infrared optical element that is a light-emitting element. The optical filters are also arranged in the optical path upstream from the infrared optical element that is a light-receiving element. The optical filters are arranged with a gap between them. Here, da is the distance between the infrared light-emitting element and the nearest optical filter. In addition, db is the distance between the infrared light-receiving element and the nearest optical filter. At least one of da and db may be zero. That is, at least one of the plurality of optical filters may be integrated with the infrared optical element (at least one of the light-emitting element and the light-receiving element). For example, at least one of the plurality of optical filters may be directly laminated on the infrared optical element. In this case, the optical filter that is directly laminated may share a substrate with the infrared optical element. Sharing of the substrate makes it possible to reduce the optical module in size. However, in cases such as the degree of design freedom being more important than miniaturization, the substrate need not be shared. For example, a filter substrate, which is at least one substrate among the plurality of optical filters, may be of a different type from an optical element substrate, which is a substrate of the infrared optical element. The filter substrate and the optical element substrate may be bonded together. In addition, the optical module is not limited to the configuration illustrated in FIG. 5 and may, for example, have a configuration in which other optical members such as lenses or mirrors are further arranged in the optical path.

Below, the details of the components of the optical module according to the present embodiment will be described. Here, the optical module includes at least one of the infrared light-receiving element and the infrared light-emitting element, and the light-receiving sensitivity of the infrared light-receiving element and the light-emitting intensity of the infrared light-emitting element are described as “sensitivity”. That is, sensitivity can be interpreted as light-receiving sensitivity if the optical module is configured to include an infrared light-receiving element, and as light-emitting intensity if the optical module is configured to include an infrared light-emitting element.

### (Optical Filter)

The optical filter includes, as described above, a substrate and a multilayer film formed on the substrate, the multilayer film including a plurality of layers having different refractive indices. The multilayer film may be formed only on one side of the substrate or may be formed on both sides. The optical filter is installed on the optical path where infrared light emitted from the infrared light-emitting element reaches the infrared light-receiving element in the concentration measurement device. The optical filter can be made by forming a first layer and a second layer on the substrate by vapor deposition.

The plurality of optical filters include at least a first optical filter and a second optical filter that is separate from the first optical filter. The first optical filter and the second optical filter include 50 nm or more of a common transmission band with a transmittance of 60% or more in a wavelength range of 2000 nm to 10000 nm, and a total of 200 nm or more of a wavelength range in which a transmittance difference between at least two of the plurality of optical filters is 20% or more outside the common transmission band. Furthermore, the first optical filter and the second optical filter include a total of 1000 nm or more of a wavelength range in which the transmittance difference is less than 20% and the transmittance is less than 60% in a band closer to the common transmission band than the wavelength range in which the transmittance difference is 20% or more on both sides of the common transmission band. The plurality of optical filters preferably include a total of 50 nm or more of a wavelength range in which the transmittance difference between at least two of the plurality of optical filters is 30% or more in the wavelength range of 2000 nm to 10000 nm. In addition, the infrared optical element has peak sensitivity in the wavelength range of 2000 nm to 10000 nm, and when the sensitivity spectrum of the infrared optical element is multiplied by the transmission spectra of the plurality of optical filters, the sensitivity in a cutoff band is 5% or less of the peak sensitivity. Here, in the wavelength range of 2000 nm to 10000 nm, when the sensitivity spectrum of the infrared optical element is multiplied by the transmission spectra of the plurality of optical filters, the sensitivity in the cutoff band is more preferably 2% or less of the peak sensitivity.

Here, the transmittance varies depending on the measurement conditions. Specifically, the transmittance varies depending on temperature and the angle of incidence of light. In the present embodiment, the temperature is assumed to be 25° C. Also, the angle of incidence of light can, for example, be 0°, 10°, 20°, 30°, 40°, 45°, or the like, depending on the design of the concentration measurement device, but it suffices for the above characteristics to be satisfied at any one angle of incidence. For example, it suffices for the optical filter to satisfy the above characteristics at least at one of the angles of incidence that can be set in the design (for example, 30°). Here, the optical filter more preferably satisfies the above characteristics at all angles of incidence that can be set in the design.

At least one of the plurality of optical filters preferably has a total film thickness of the multilayer film of (λp×1.5) nm or less, where λp is a center wavelength of the transmission band. Here, the center wavelength is the wavelength that is the center of the half-width of the transmission band with the maximum transmittance in the wavelength range of 2000 nm to 10000 nm. Also, the half-width is the width of the wavelength at which the transmittance becomes half of the maximum transmittance (i.e., the difference between the maximum wavelength and the minimum wavelength).

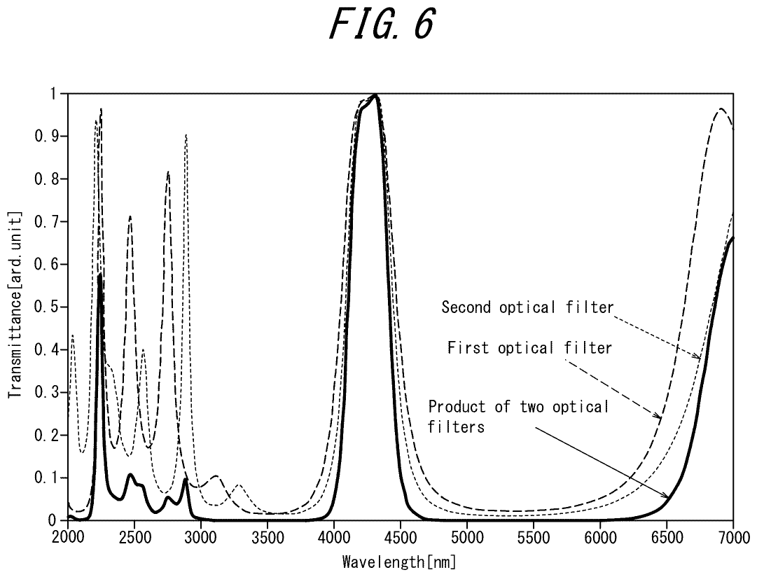

The plurality of optical filters include the first optical filter and the second optical filter, and the difference between the half-width of the first optical filter and the half-width of the second optical filter may be 1500 nm or less. Here, regarding the change in the transmittance of the plurality of optical filters according to the wavelength (transmission spectrum, see FIG. 6), if there is a relationship as described below for the slopes before and after the center wavelength, the transmission spectrum as an overall characteristic can be made sharp. First, the slope is defined as the value yielded by dividing the wavelength width (bandwidth) Δπ1 from the point at which transmittance is 10% (transmittance point) to the 80% transmittance point by the center wavelength λp (Δλ1/λp). The slope can also be defined as (Δλ2/λp), with Δλ2 being the wavelength width from the 80% transmittance point to the 10% transmittance point. As in the calculation method in Table 1 described below, (Δλ1/λp) and (Δλ2/λp) are calculated, and the larger of the two values may be defined as the slope of the transmission spectrum. If the slope of the transmission spectrum of at least one of the plurality of optical filters is 3.3% or more, it is possible to make the transmission spectrum sharp as an overall characteristic while reducing the film thickness of the optical filter. If the slope of the transmission spectrum of at least one of the plurality of optical filters is 4.2% or more, it is possible to make the transmission spectrum sharp as an overall characteristic while further reducing the film thickness of the optical filter, thereby simplifying the optical filter.

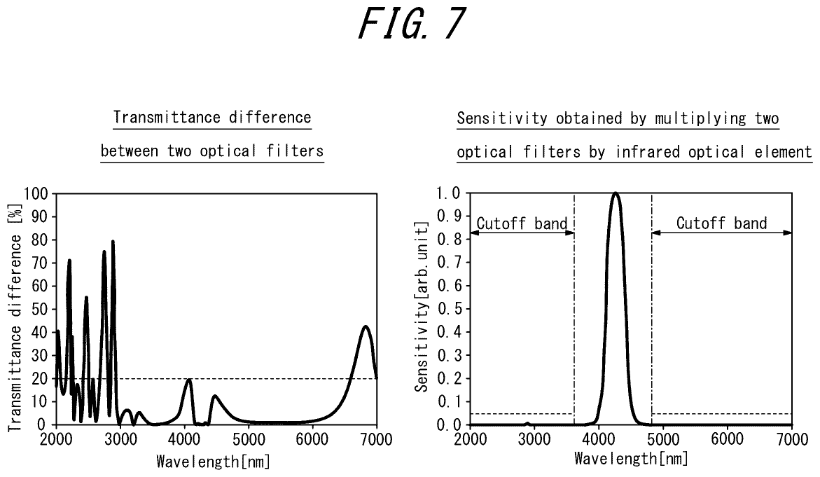

In any 1000 nm interval of the cutoff band, a wavelength range preferably exists such that the transmittance difference is 5% or less between wavelength ranges in which the transmittance difference is 20% or more for at least two of the plurality of optical filters. For example, a configuration is preferably adopted so that in any 1000 nm interval of the cutoff band, there exists a region such that the maxima of the transmission spectrum of at least two of the plurality of optical filters do not overlap (see the region from 2000 nm to 3000 nm in the left side of FIG. 7). Here, in the common transmission band, the relationship of 0.5< (A/B)<2 may be satisfied, where A is the half-width of one optical filter and B is the half-width of another optical filter among the plurality of optical filters. Furthermore, the relationship 0.7< (A/B)<1.3 may be satisfied for A and B. Two or more film thicknesses among the plurality of optical filters may be equal to or less than the (center wavelength×1.5). When transmission spectra of the plurality of optical filters are multiplied, the slope of the resulting transmission spectrum may be smaller than the slope of the transmission spectrum of all individual optical filters.

### (Substrate)

The substrate may be suitable for forming each layer constituting the multilayer film. Examples include silicon substrates, germanium substrates, sapphire substrates, or glass substrates, but the substrate is not limited to these examples.

### (Multilayer Film)

The multilayer film is a film having a plurality of layers with different refractive indices. In the present embodiment, the multilayer film includes a structure in which a first layer having a refractive index of 1.2 or more and 2.5 or less in the wavelength range of 6 μm to 10 μm and a second layer having a refractive index of 3.2 or more and 4.3 or less in the wavelength range of 6 μm to 10 μm are alternately stacked. The first layer is made of the aforementioned low refractive index material (L). The second layer is made of the aforementioned high refractive index material (H).

### (First Layer)

Specific materials for the first layer include titanium dioxide, zinc sulfide, silicon monoxide, and silicon dioxide.

### (Second Layer)

Specific materials for the second layer include silicon (Si) and germanium (Ge).

### (Method of Measuring Refractive Index)

The refractive indices of the first layer and the second layer can be measured using an ellipsometer in accordance with “JIS K7142”.

Here, the sensitivity range of the infrared optical element is influenced by the density of states and the Boltzmann distribution. By optimally designing the bandgap energy, it is possible to realize an infrared optical element that has high sensitivity in a specific absorption wavelength range corresponding to the gas to be detected, while having low sensitivity in other wavelength ranges. As a result, for example, the cutoff at 2000 nm to 3500 nm and 4800 nm to 10000 nm (see FIG. 7) becomes less important, allowing for simplification of optical filter design.

Here, the material and film thickness of each of the plurality of stacked first layers may be the same or different. Also, the material and film thickness of each of the plurality of stacked second layers may be the same or different. The multilayer film may further include layers different from the first layer and the second layer.

The total film thickness of the multilayer film is the sum of the thicknesses of the cut surface and the bandpass surface. By reducing the total film thickness, the manufacturing time is shortened and the yield is improved in the production of optical filters. The film thickness can be measured by cross-sectional SEM observation. Each of the plurality of optical filters preferably has a total film thickness of the multilayer of 14 μm or less.

### (Infrared Optical Element)

The infrared optical element may be configured to have a first conductivity type semiconductor layer, an active layer, and a second conductivity type semiconductor layer. Specifically, the infrared optical element is an infrared light-emitting diode or an infrared photodiode.

The active layer is a light-absorbing layer or a light-emitting layer (see FIG. 8). In the present embodiment, the active layer is formed of Al_{y}In_{1-y}Sb (0.04≤y≤0.14) or InAs_{y}Sb_{1-y}(0.1≤y≤0.2). “Al_{y}In_{1-y}Sb (0.04≤y≤0.14)” means that Al, In, and Sb are contained within the layer, but this expression also includes cases in which other elements are present. Specifically, this expression also includes cases where slight changes are made to the composition of this layer by adding a small amount of other elements (for example, several percent or less of elements such as As, P, Ga, and N). This is similarly true for expressions of other compositions.

Here, the Al composition or As composition can be determined, for example, by secondary ion mass spectrometry (SIMS). For example, a magnetic field type SIMS device IMS 7f, manufactured by CAMECA, can be used for measurement.

The second conductivity type is a different conductivity type from the first conductivity type. The first conductivity type and the second conductivity type may each be any of n-type (including n-type impurities), i-type (without impurities), or p-type (including p-type impurities). The first conductivity type semiconductor layer may be composed of, for example, n-type InSb (see FIG. 8). Also, the second conductivity type semiconductor layer may be composed of, for example, p-type InSb (see FIG. 8). In the present embodiment, the first conductivity type is n-type, and the second conductivity type is p-type.

The first conductivity type semiconductor layer, active layer, and second conductivity type semiconductor layer may be formed on a semiconductor substrate such as a gallium arsenide (GaAs) substrate or a silicon substrate. In the present embodiment, the first conductivity type semiconductor layer, active layer, and second conductivity type semiconductor layer are arranged in this order from the substrate in the infrared optical element. As another example, the second conductivity type semiconductor layer, active layer, and first conductivity type semiconductor layer may be arranged in this order from the substrate in the infrared optical element.

A barrier layer consisting of one or more layers may be provided between the first conductivity type semiconductor layer and the active layer. Also, a barrier layer consisting of one or more layers may be provided between the active layer and the second conductivity type semiconductor layer. In the present embodiment, an n-type barrier layer is provided between the first conductivity type semiconductor layer and the active layer, and a p-type barrier layer is provided between the active layer and the second conductivity type semiconductor layer. The n-type barrier layer is composed of, for example, n-type AlₓIn₁₋ₓSb (0.15≤x≤0.35) (see FIG. 8). The p-type barrier layer is composed of p-type Al_{z}In_{1-z}Sb (0.15≤z≤0.35) (see FIG. 8).

The infrared optical element preferably has a ratio of maximum sensitivity to minimum sensitivity of 20 or more in the wavelength range of 2000 nm to 10000 nm.

### Examples

The effects of the present disclosure will be described in detail below based on examples, but the present disclosure is not limited to these examples.

Examples 1 to 4 and Comparative Examples 1 to 3, illustrated in Table 1, were evaluated. Examples 1 to 4 are optical modules of the present embodiment, endowed with the characteristics in Table 1. Comparative Examples 1 to 3 are non-simplified filter units. FIG. 8 is a diagram illustrating a laminated structure of the infrared optical element of Examples 1 to 4. The center wavelength of the optical filters in Examples 1, 4, and Comparative Example 1 is 4.3 μm. The center wavelength of the optical filters in Example 2 and Comparative Example 2 is 3.4 μm. The center wavelength of the optical filters in Example 3 and Comparative Example 3 is 8.5 μm. The optical modules of Examples 1, 2, and 4 include an infrared light-emitting element and an infrared light-receiving element. The optical module of Example 3 includes only an infrared light-emitting element. The active layer of the infrared light-emitting element in Examples 1, 2, and 4 is formed by Al_{y}In_{1-y}Sb, with y being 0.057 in Example 1, 0.089 in Example 2, and 0.057 in Example 4. The active layer of the infrared light-receiving element in Examples 1, 2, and 4 is formed by Al_{y}In_{1-y}Sb, with y being 0.048 in Example 1, 0.089 in Example 2, and 0.048 in Example 4. The active layer of the infrared light-emitting element in Example 3 is formed by InAs_{y}Sb_{1-y}, with y being 0.13.

TABLE 1

| | | | Exam- | | Exam- | | Exam- | |
|---|---|---|---|---|---|---|---|---|
| | | | ple 1 | | ple 2 | | ple 3 | |
| Optical | Substrate | Material | Si | | Si | | Si | |
| filter | Multilayer | Material of first layer | SiO | | SiO | | ZnS | |
| | film | Material of second layer | Ge | | Ge | | Ge | |
| | | Total film thickness of first optical filter | 4.1 | μm | 3.2 | μm | 12.0 | μm |
| | | Total film thickness of second optical filter | 3.6 | μm | 3.3 | μm | 10.0 | μm |
| | | Total film thickness of third optical filter | — | | — | | — | |
| | | Total of total film thickness of all optical filters | 7.7 | μm | 6.5 | μm | 22.0 | μm |
| | | Slope of transmission spectrum of first optical filter | 6.8% | | 5.3% | | 9.6% | |
| | | Slope of transmission spectrum of second optical filter | 4.9% | | 5.9% | | 16.9% | |
| | | Slope of transmission spectrum of third optical filter | — | | — | | — | |
| | | Slope of overall transmission spectrum | 3.0% | | 2.9% | | 3.3% | |
| | Characteristics | Width of common wavelength range with a transmittance of 60% or | 440 | nm | 400 | nm | 620 | nm |
| | | more | | | | | | |

| Total wavelength range with a transmittance difference of 20% or | 200 nm or | 200 nm or | 200 nm or |
|---|---|---|---|
| more | more | more | more |
| (Value) | (900 nm) | (630 nm) | (3140 nm) |
| Total wavelength range with a transmittance difference of 30% or | 50 nm or | 50 nm or | 50 nm or |
| more | more | more | more |
| (Value) | (620 nm) | (270 nm) | (1880 nm) |
| Total of the wavelength range in which the transmittance difference | 1000 nm or | 1000 nm or | 1000 nm or |
| is less than 20% and the transmittance is less than 60% in a band | more | more | more |
| closer to the common transmission band than the wavelength range in | (3240 nm) | (2920 nm) | (1460 nm) |
| which the transmittance difference is 20% or more on both sides of | | | |
| the transmission band | | | |
| (Value) | | | |
| In any 1000 nm interval of the cutoff band, a wavelength range exists | Yes | Yes | Yes |
| such that the transmittance difference is 5% or less between wavelength | | | |
| ranges in which the transmittance difference is 20% or more | | | |

| | | Half-width of optical filter | 1: 430 nm | 1: 340 nm | 1: 760 nm |
|---|---|---|---|---|---|
| | | | 2: 370 nm | 2: 340 nm | 2: 800 nm |
| Infrared | Light receiving | Maximum sensitivity (normalized to 1) | 1 | 1 | — |
| optical | characteristics | Minimum sensitivity | 0.01 or less | 0.01 or less | — |
| element | Light emission | Maximum sensitivity (normalized to 1) | 1 | 1 | 1 |
| | characteristics | Minimum sensitivity | 0.01 or less | 0.01 or less | 0.01 or less |

| | | | | | Compar- | Compar- | Compar- |
|---|---|---|---|---|---|---|---|
| | | | | | ative | ative | ative |
| | | | Exam- | | Exam- | Exam- | Exam- |
| | | | ple 4 | | ple 1 | ple 2 | ple 3 |
| Optical | Substrate | Material | Si | | Si | Si | Si |
| filter | Multilayer | Material of first layer | SiO | | SiO | SiO | ZnS |
| | film | Material of second layer | Ge | | Ge | Ge | Ge |
| | | Total film thickness of first optical filter | 3.8 | μm | 17.1 μm | 22.0 μm | 33.9 μm |
| | | Total film thickness of second optical filter | 1.4 | μm | — | — | — |
| | | Total film thickness of third optical filter | 1.4 | μm | — | — | — |
| | | Total of total film thickness of all optical filters | 6.6 | μm | — | — | — |
| | | Slope of transmission spectrum of first optical filter | 4.2% | | 2.6% | 3.2% | 2.6% |
| | | Slope of transmission spectrum of second optical filter | 25.7% | | — | — | — |
| | | Slope of transmission spectrum of third optical filter | 25.7% | | — | — | — |
| | | Slope of overall transmission spectrum | 4.0% | | — | — | — |
| | Characteristics | Width of common wavelength range with a transmittance of 60% or | 310 | nm | — | — | — |
| | | more | | | | | |

| Total wavelength range with a transmittance difference of 20% or | 200 nm or | — | — | — |
|---|---|---|---|---|
| more | more | | | |
| (Value) | (3370 nm) | | | |
| Total wavelength range with a transmittance difference of 30% or | 50 nm or | — | — | — |
| more | more | | | |
| (Value) | (2450 nm) | | | |
| Total of the wavelength range in which the transmittance difference | 1000 nm or | — | — | — |
| is less than 20% and the transmittance is less than 60% in a band | more | | | |
| closer to the common transmission band than the wavelength range in | (1080 nm) | | | |
| which the transmittance difference is 20% or more on both sides of | | | | |
| the transmission band | | | | |
| (Value) | | | | |
| In any 1000 nm interval of the cutoff band, a wavelength range exists | Yes | — | — | — |
| such that the transmittance difference is 5% or less between wavelength | | | | |
| ranges in which the transmittance difference is 20% or more | | | | |

| | | Half-width of optical filter | 1: 340 nm | — | — | — |
|---|---|---|---|---|---|---|
| | | | 2: 1010 nm | | | |
| | | | 3: 1010 nm | | | |
| Infrared | Light receiving | Maximum sensitivity (normalized to 1) | 1 | — | — | — |
| optical | characteristics | Minimum sensitivity | 0.01 or less | — | — | — |
| element | Light emission | Maximum sensitivity (normalized to 1) | 1 | — | — | — |
| | characteristics | Minimum sensitivity | 0.01 or less | — | — | — |

The PIN diode structure of the infrared optical elements in Examples 1 to 4 was created by the MBE method. N-type and p-type barrier layers were provided so as to sandwich the active layer. An i-line positive photoresist was coated on the surface of a semiconductor wafer, and exposure was carried out using the i-line with a reduction projection-type exposure machine. Subsequently, development was performed, and a resist pattern was regularly formed on the surface of the semiconductor stacked portion. A plurality of mesas was then formed by dry etching. After forming a silicon dioxide film as a hard mask on the element having a mesa shape, elements were isolated by dry etching, a silicon nitride (SiN) film was formed as a protective film, and contact holes were formed by photolithography and dry etching. Subsequently, a plurality of mesas was connected in series by photolithography and sputtering, and the element surface was covered with a protective film of polyimide resin. The wafer prepared as described above was diced into individual pieces, bonded with Au wires and wired to a lead frame, and encapsulated with epoxy molding resin so that the light-receiving surface was exposed. The infrared light-receiving element prepared in this way had sensitivity to infrared light around λp while being a cutoff band with little sensitivity in other bands.

The optical filter was designed using simulations. The optical filters in Examples 1 to 4 are configured by a plurality of simplified optical filters and achieve the desired wavelength selectivity as overall characteristics. FIG. 6 is a diagram illustrating the transmittance of the Examples, specifically illustrating Example 1. The left side of FIG. 7 illustrates the transmittance difference of two optical filters for Example 1. In Example 1, two simplified optical filters are used, and by multiplying the transmission spectrum of the first optical filter by that of the second optical filter, the desired wavelength selectivity was obtained. Similarly, Examples 2 to 4 also achieved the desired wavelength selectivity through a combination of a plurality of simplified optical filters. The optical filters of Examples 1 to 4 include 50 nm or more of a common transmission band with a transmittance of 60% or more in a wavelength range of 2000 nm to 10000 nm, and a total of 200 nm or more of a wavelength range in which a transmittance difference between at least two of the plurality of optical filters is 20% or more. As illustrated in Table 1, for the common transmission band, Example 1 is 440 nm, Example 2 is 400 nm, Example 3 is 620 nm, and Example 4 is 310 nm, all corresponding to 50 nm or more. Also, regarding the transmittance difference of 20% or more, Example 1 is 900 nm, Example 2 is 630 nm, Example 3 is 3140 nm, and Example 4 is 3370 nm, all corresponding to 200 nm or more. Furthermore, the optical filters in Examples 1 to 4 include a total of 50 nm or more of a wavelength range in which the transmittance difference is 30% or more for at least two of the plurality of optical filters in the wavelength range of 2000 nm to 10000 nm. As illustrated in Table 1, regarding the transmittance difference of 30% or more, Example 1 is 620 nm, Example 2 is 270 nm, Example 3 is 1880 nm, and Example 4 is 2450 nm, all corresponding to 50 nm or more. Furthermore, the optical filters of Examples 1 to 4 include a total of 1000 nm or more of a wavelength range in which the transmittance difference is less than 20% and the transmittance is less than 60% in a band closer to the common transmission band than the wavelength range in which the transmittance difference is 20% or more on both sides of the transmission band. As illustrated in Table 1, Example 1 is 3240 nm, Example 2 is 2920 nm, Example 3 is 1460 nm, and Example 4 is 1080 nm, all corresponding to 1000 nm or more. Furthermore, the optical filters in Examples 1 to 4 satisfy the relationship of 0.5<A/B<2, where A is the half-width of one optical filter and B is the half-width of the other optical filter. As illustrated in Table 1, Examples 1 to 3 satisfy the relationship of 0.5<A/B<2 between the first optical filter and the second optical filter. Also, Example 4 satisfies the relationship of 0.5<A/B<2 between the second optical filter and the third optical filter. Additionally, the right side of FIG. 7 illustrates the sensitivity obtained by multiplying the transmission spectra of the two optical filters for Example 1 by the sensitivity spectrum of the infrared optical element. The sensitivity in the cutoff band was similar for Examples 2 to 4. In other words, in the optical modules of Examples 1 to 4, it was confirmed that when the sensitivity spectrum of the infrared optical element is multiplied by the transmission spectra of the plurality of optical filters, the sensitivity in the cutoff band is 5% or less of the peak sensitivity, as illustrated in FIG. 7.

Moreover, as illustrated in Table 1, in Examples 1 to 4, the slope of the overall transmission spectrum is sharper than the slopes of the transmission spectra of each of the plurality of optical filters. In Examples 1 to 4, each of the plurality of optical filters has a total film thickness of 14 μm or less. In Examples 1 to 3, as is clear from the comparison with Comparative Examples 1 to 3, even while using two optical filters, the total film thickness of all optical filters can be made thinner. In Example 4, even while using three optical filters, the total film thickness of all optical filters is thinner than that of Comparative Example 1 and Example 1. In other words, the Examples have a sensitivity equivalent to that of the Comparative Examples while the film thickness of the multilayer films of the plurality of optical filters is reduced.

As described above, the optical module according to the present embodiment can enhance the yield of each optical filter by using a simplified plurality of optical filters, thereby improving mass productivity.

While embodiments of the present disclosure have been described with reference to the drawings and examples, it should be noted that various modifications and amendments may easily be implemented by those skilled in the art based on the present disclosure. Accordingly, such modifications and amendments are included within the scope of the present disclosure.

1. An optical module comprising:
a plurality of optical filters including at least a first optical filter and a second optical filter separate from the first optical filter, and an infrared optical element having peak sensitivity in a wavelength range of 2000 nm to 10000 nm, wherein
at least one of the first optical filter and the second optical filter is configured to include a substrate and a multilayer film formed on at least one surface of the substrate, the multilayer film including a plurality of layers having different refractive indices,
the first optical filter and the second optical filter include 50 nm or more of a common transmission band with a transmittance of 60% or more in the wavelength range of 2000 nm to 10000 nm, a total of 200 nm or more of a wavelength range in which a transmittance difference is 20% or more outside the common transmission band, and a total of 1000 nm or more of a wavelength range in which the transmittance difference is less than 20% and the transmittance is less than 60% in a band closer to the common transmission band than the wavelength range in which the transmittance difference is 20% or more on both sides of the common transmission band, and
a sensitivity in a cutoff band is 5% or less of the peak sensitivity as a result of multiplying a sensitivity spectrum of the infrared optical element by a transmission spectra of the plurality of optical filters.

2. The optical module according to claim 1, wherein at least one of the plurality of optical filters is directly laminated on the infrared optical element and shares a substrate with the infrared optical element.

3. The optical module according to claim 1, wherein a filter substrate, which is at least one substrate among the plurality of optical filters, is of a different type from an optical element substrate, which is a substrate of the infrared optical element, and
the filter substrate and the optical element substrate are bonded together.

4. The optical module according to claim 1, wherein at least one of the plurality of optical filters has a total film thickness of the multilayer film of (λp×1.5) nm or less, where λp is a center wavelength of the transmission band.

5. The optical module according to claim 1, wherein the plurality of optical filters includes the first optical filter and the second optical filter, and
a difference between a half-width of the first optical filter and a half-width of the second optical filter is 1500 nm or less.

6. The optical module according to claim 1, wherein each of the plurality of optical filters including the multilayer film has a total film thickness of the multilayer of 14 μm or less.

7. The optical module according to claim 1, wherein the infrared optical element has a ratio of maximum sensitivity to minimum sensitivity of 20 or more in the wavelength range of 2000 nm to 10000 nm.

8. The optical module according to claim 1, wherein the plurality of optical filters includes, in the wavelength range of 2000 nm to 10000 nm, a total of 50 nm or more of a wavelength range in which a transmittance difference between at least two of the plurality of optical filters is 30% or more, and
in the wavelength range of 2000 nm to 10000 nm, when the sensitivity spectrum of the infrared optical element is multiplied by the transmission spectra of the plurality of optical filters, the sensitivity in the cutoff band is 2% or less of the peak sensitivity.

9. The optical module according to claim 1, wherein in any 1000 nm interval of the cutoff band, a wavelength range exists such that the transmittance difference is 5% or less between wavelength ranges in which the transmittance difference is 20% or more for at least two of the plurality of optical filters.

10. The optical module according to claim 1, wherein a slope of a transmission spectrum of at least one of the plurality of optical filters is 3.3% or more.

11. The optical module according to claim 1, wherein all of the plurality of optical filters are configured to include a substrate and a multilayer film formed on at least one surface of the substrate, the multilayer film including a plurality of layers having different refractive indices.

12. The optical module according to claim 1, wherein in the common transmission band, a relationship of 0.5< (A/B)<2 is satisfied, where A is a half-width of one optical filter and B is a half-width of another optical filter among the plurality of optical filters.

13. The optical module according to claim 12, wherein a relationship 0.7< (A/B)<1.3 is satisfied for A and B.

14. The optical module according to claim 1, wherein two or more film thicknesses among the plurality of optical filters are equal to or less than a center wavelength×1.5.

15. The optical module according to claim 1, wherein when the transmission spectra of the plurality of optical filters are multiplied, a slope of a resulting transmission spectrum is smaller than a slope of the transmission spectrum of all individual optical filters.
